(19) United States
(12) Patent Application Publication
(10) Pub. No.: US 2014/0059424 A1
(43) Pub. Date: Feb. 27, 2014

(54) RESPONSIVE USER INTERFACE FOR DISPLAY DEVICES

(71) Applicants: Chang Gyum Kim, Chuncheon (KR); Jae Hyun Lim, Jeonju (KR); Ah Young Hwang, Seoul (KR)

(72) Inventors: Chang Gyum Kim, Chuncheon (KR); Jae Hyun Lim, Jeonju (KR); Ah Young Hwang, Seoul (KR)

(73) Assignee: LG CNS CO., LTD., Seoul (KR)

(21) Appl. No.: 13/591,416

(22) Filed: Aug. 22, 2012

(51) Int. Cl. G06F 17/21

(52) U.S. Cl. CPC G06F 17/212
USPC 715/235; 715/252; 715/234

(57) ABSTRACT

Embodiments of the present invention provide an approach for displaying data in a single format on a variety of display device types. Specifically, data from a single source is received for a display device among multiple display devices. A layout for the data is loaded for the display device. The layout is scaled for the display device based on the display device type. A first rendering of the data using the scaled layout is performed. The layout is modified based on the screen size of the display device for optimization. The data is rendered a second time based on the modified layout. The rendering is displayed on the display device as a common user interface.

### TECHNICAL FIELD

In general, embodiments of the present invention provide an approach for displaying data on display devices. Specifically, embodiments of the present invention relate to an approach for displaying data in a single format on a variety of display device types.

### BACKGROUND

The growth of electronic display devices such as mobile phones, computers, and personal digital assistants (PDAs) has exploded in recent years. Electronic display devices are well known and used for a wide variety of applications for which information, and user interaction with information, are critical. Given the plethora of information presented to users of electronic display devices, it is important that the displays be efficiently used so as to present as much useful information as possible while maintaining clarity and ease of use when interacting with the presented information.

In today's world, it is increasing likely that one person may own several of the various electronic display devices. Having a variety of different display devices, however, can make it difficult for a user to navigate, find, and browse the different types of data content because most of the different display devices on the market today have a unique interface. A single user of multiple display devices, therefore, must learn a new interface for each new display device to consume the same content on the different display devices. For some users, it can be difficult to switch between the many different devices and the different user interfaces.

In addition, the frequent development of new programming efforts for different devices increases the development costs and maintenance. When a new device is introduced, the lack of responsiveness of the new device continues to occur in a mobile environment. One current technology is to use the cascading style sheet (CSS) media queries which can control various display devices, but a complex system in an enterprise environment may not work smoothly. Typically, the screen layout and user interface design theme are selected by the developer of the different devices and, therefore, quality control becomes an issue. Heretofore, several unsuccessful attempts have been made to address these shortcomings.

U.S. Patent Application 20100020102 discloses a method for browsing information on a hand-held device having a display by adjusting the view on the display device in a manner as natural as possible so that the user of the hand-held device can concentrate on the information displayed on the display device and not on the adjustment of the displayed information.

U.S. Patent Application 20100060549 discloses methods and systems that dynamically generate different user environments from a handheld device for secondary devices with displays of various form factors.

U.S. Pat. No. 6,976,226 discloses a method and system that translates tabular data prepared for one display format into a second display format.

U.S. Pat. No. 6,948,002 discloses a method and system of interfacing a computer system executing commercial transactions initiated from communication devices, each communication device having a display with custom display parameters.

U.S. Pat. No. 6,636,243 discloses a system and method for displaying a status of critical indicators on diverse display devices and indicating a history of change statuses.

U.S. Pat. No. 6,181,300 discloses a display data format conversion circuit and method that facilitates display of data on a plurality of display devices based on display data of a source display device.

None of these references, however, teach a single user interface tool that varies the display and size when rendering data from a single source on multiple display devices.

### SUMMARY

In general, embodiments of the present invention provide an approach for displaying data in a single format on a variety of display device types. Specifically, data from a single source is received for a display device among multiple display devices. A layout for the data is loaded for the display device. The layout is scaled for the display device based on the display device type. A first rendering of the data using the scaled layout is performed. The layout is modified based on the screen size of the display device for optimization. The data is rendered a second time based on the modified layout. The rendering is displayed on the display device as a common user interface.

A first aspect of the present invention provides a computer-implemented method for displaying a common user interface on a display device among a plurality of display devices, comprising: receiving data intended for display on a display device having a screen; loading a common layout structure; determining a size of the screen; scaling the common layout structure based on the size of the screen; performing a first rendering of the data using the scaled common layout structure; modifying the scaled common layout structure based on the size of the screen; performing a second rendering of the data using the modified common layout structure; and displaying the second rendering on a screen of a display device as a common user interface.

A second aspect of the present invention provides a system for displaying a common user interface on a display device among a plurality of display devices, comprising: a receiving component configured to receive data intended for display on a screen of a display device; a loading component configured to load a common layout structure; a determining component configured to determine a size of the screen; a scaling component configured to scale the common layout structure based on the size of the screen; a rendering component configured to perform a first rendering of the data using the scaled common layout structure; a modifying component configured to modify the scaled common layout structure based on the size of the screen; the rendering component further configured to perform a second rendering of the data using the modified common layout structure; and a providing component configured to provide the second rendering to the display device as a common user interface.

A third aspect of the present invention provides a computer program product for generating a common user interface for a display device among a plurality of display devices, the computer program product comprising a computer readable storage medium, and program instructions stored on the computer readable storage medium, to: receive data intended for a screen of a display device; load a common layout structure; determine a size of the screen; scale the common layout structure based on the size of the screen; perform a first rendering of the data using the scaled common layout structure; modify the scaled common layout structure based on the size of the screen; and perform a second rendering of the data using the modified common layout structure, wherein the second rendering represents a common user interface.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an example data from a single source displayed on different display device types according to an embodiment of the present invention.

FIG. 2 shows example display layouts which can be implemented on different display device types according to an embodiment of the present invention.

FIGS. 3A-C show example display formats based on the type of data being presented according to an embodiment of the present invention.

FIG. 4 shows an example method flow diagram for providing a common user interface for multiple devices according to an embodiment of the present invention.

FIG. 5 shows a detailed example method flow diagram for providing a common user interface for each of multiple devices via a cascading style sheet (CSS) and javascript according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Embodiments of the present invention provide an approach for displaying data in a single format on a variety of display device types. Specifically, data from a single source is received for a display device among multiple display devices. A layout for the data is loaded for the display device. The layout is scaled for the display device based on the display device type. A first rendering of the data using the scaled layout is performed. The layout is modified based on the screen size of the display device for optimization. The data is rendered a second time based on the modified layout. The rendering is displayed on the display device as a common user interface.

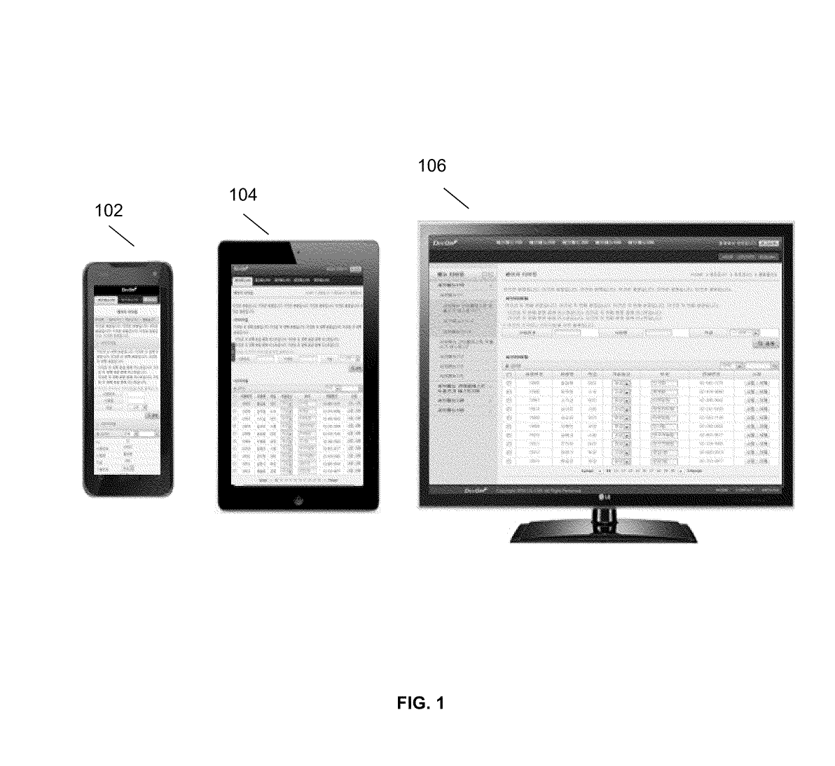

FIG. 1 shows an example data from a single source displayed on different display device types according to an embodiment of the present invention. As depicted, the display device types include a smartphone 102, tablet 104, and desktop 106. A display device type may include a desktop, laptop, notebook, tablet, personal data assistant (PDA), cell phone, smartphone, or any electronic device having a display screen. The display screen may be a liquid crystal display (LCD), light-emitting diode (LED), plasma, projection, cathode ray tube (CRT), or any other appropriate illumination screen.

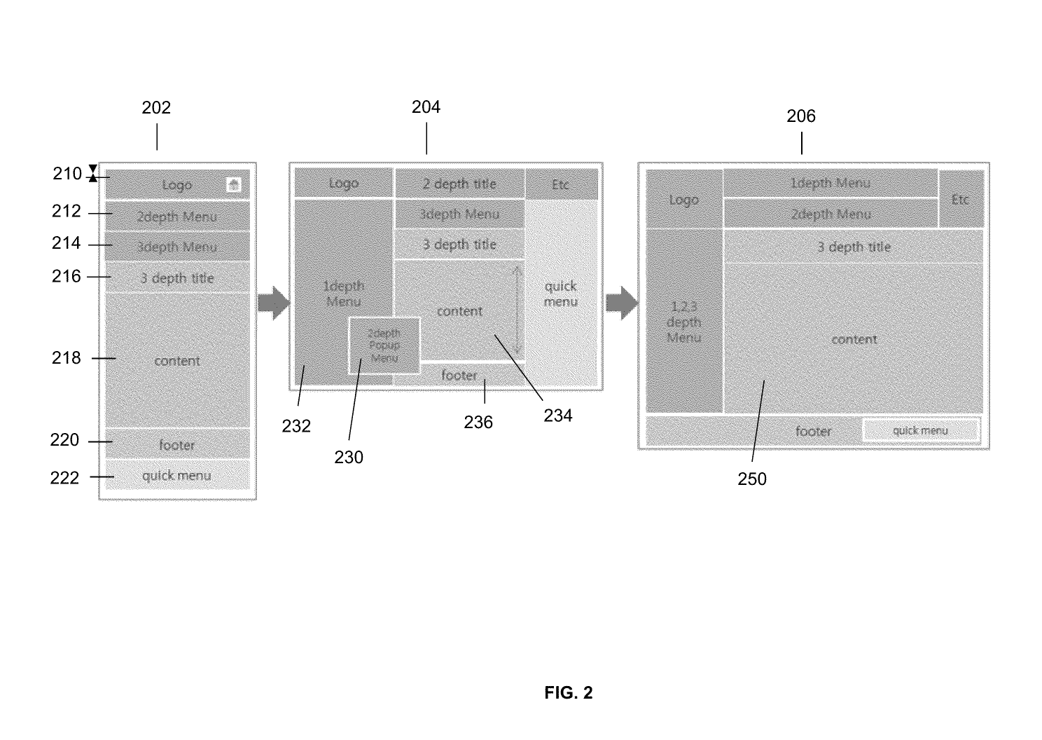

FIG. 2 shows example display layouts which can be implemented on different display device types according to an embodiment of the present invention. Each layout illustrates various regions for displaying data to a user. For example, smartphone layout 202 includes logo 210, 2 depth menu 212, 3 depth menu 214, 3 depth title 216, content 218, footer 220, and quick menu 222.

The layout of each display device for displaying data may differ depending on the device. For example, smartphone layout 202 may comprise only a single column due to the slim width of the smartphone. However, tablet layout 204 may be able to include multiple columns because it may have a greater width than a smartphone. However, tablet layout 204 may have some constraints when attempting to display a large amount of data. To that end, tablet layout 204 may overlap certain regions, such as 2 depth popup menu 230 may overlap with 1 depth popup menu 232, content 234, and footer 236. Certain regions, such as content 234 may vary in size depending on the content being displayed in that region and other surrounding regions. Having the largest display screen of the three example display devices, desktop layout 206 may include multiple rows and columns of data, require no overlapping of different regions, and provide ample space for each respective region, such as content 250.

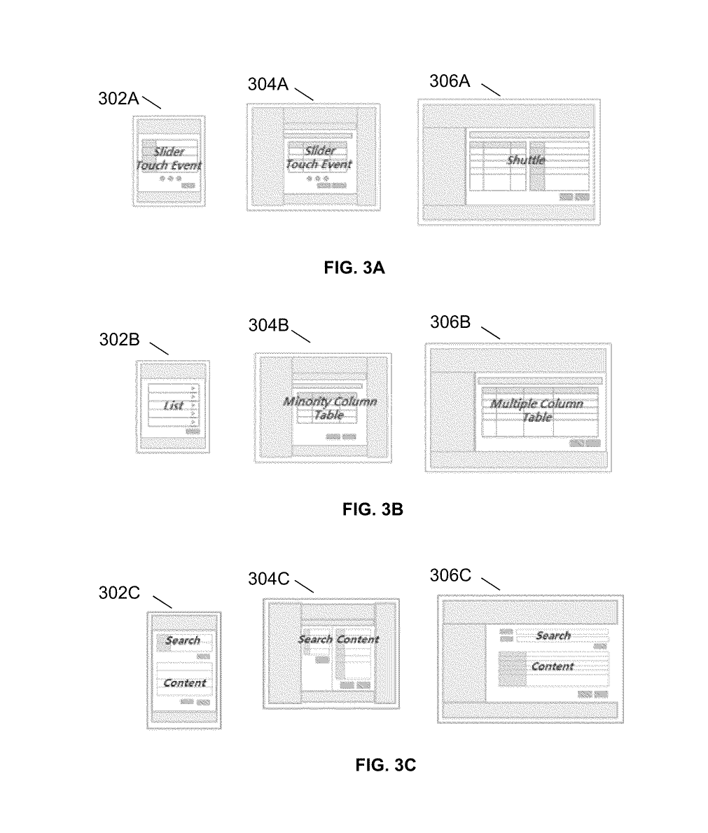

FIGS. 3A-C show example display formats based on the type of data being presented according to an embodiment of the present invention. As depicted, FIGS. 3A-C each illustrate data being displayed on a smartphone 302A-C, tablet 304A-C, and desktop 306A-C. FIG. 3A illustrates a ‘tap format’. For example, the tap format may be employed for touch events, such as a slider touch event. Use of a slider touch event as the example touch event is for illustrative purposes only and not intended to be limiting. Other touch events may use the tap format. A touch event is any event requiring the use of a touch sensor, such as a touch sensing button, slider, shuttle, touch panel, or the like.

Smartphone 302A illustrates a format requiring a slider touch event typical on many smartphones having a slider touch screen. A common user interface on today's smartphone includes a touch screen, which is an electronic visual display that can detect the presence and location of a touch within a display area. One example slider touch event is “unlocking” the phone for use. The smartphone may also have a default lock screen. The lock screen is brought up on the touch screen of the smart phone when the user wakes up the phone by, for example, depressing a wakeup button on the phone. The lock screen may provide an option to “unlock” the phone via a slider. Once the user slides the slider to unlock the phone, the other functions of the phone become available to the user. Due to the limited display area of a typical smart phone, the slider may consume much of the display screen.

Tablet 304A illustrates an example tablet tap format requiring a touch screen event. Similar to the smart phone example above, many tablets also are capable of handling one or more slider touch events, such as unlocking the tablet. However, the size of the tablet generally allows for the presentation of more data to a user to the increased display area compared to a typical smart phone.

Desktop 306A illustrates an example desktop tap format having a responsive shuttle. The desktop 306A may allow for use of a shuttle rather than the slider used in smart phone 302A and tablet 304A due to the increase display area of the desktop 306A. The display screen of a desktop typically has a greater display area than either a smart phone or tablet allowing for data to be presented in a different way and in a different size. The use of a larger display device may also allow for the display of more data on a single screen. The presentation of the same data may need more than one screen when being presented to a user on a smaller display device.

FIG. 3B illustrates a ‘table format’ for presenting data on various display devices. The data being presented on each of the display devices originates from a single data table. Smartphone 302B illustrates the table data displayed in a “list” view. In other words, due to the limited display area on the smartphone 302B, the table data is presented in a single column. Tablet 304B illustrates a minority column table. In the other words, the table data is displayed with a minimum number of columns. Alternatively, desktop 306B displays a multiple column table. In other words, the table data from the single source is presented to the users in multiple columns.

FIG. 3C illustrates a ‘view area format’ for presenting data on various display devices. The data being presented on each of the display devices includes a search region and a content region. Smartphone 302C illustrates the search region displayed above the content region, with minimal display area accommodating each region. Tablet 304C illustrates the search region and the content region displayed side-by-side on the screen. Desktop 306C displays the search and content regions. The size of each displayed region is greater compared to the respective region sizes on the smartphone 302C and tablet 304C.

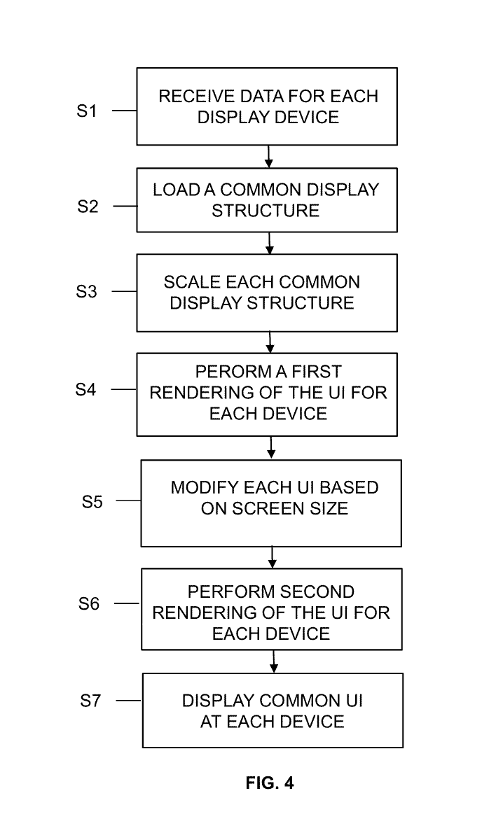

FIG. 4 shows a method flow diagram for providing a common user interface for multiple devices according to an embodiment of the present invention. At S1, data from a single source is received for a display device among multiple display devices. At S2, a layout structure is loaded for the display device. At S3, the layout structure is scaled for each display device based on the display device type. At S4, a first rendering of the data using the scaled layout structure is performed. At S5, scaled layout structure is modified based on the screen size of the display device for optimization. At S6, a second rendering of the data is performed using the modified layout structure. At S7, the second rendering is displayed on the display device as a common user interface. The process may be repeated as necessary for the remaining display devices among the multiple devices.

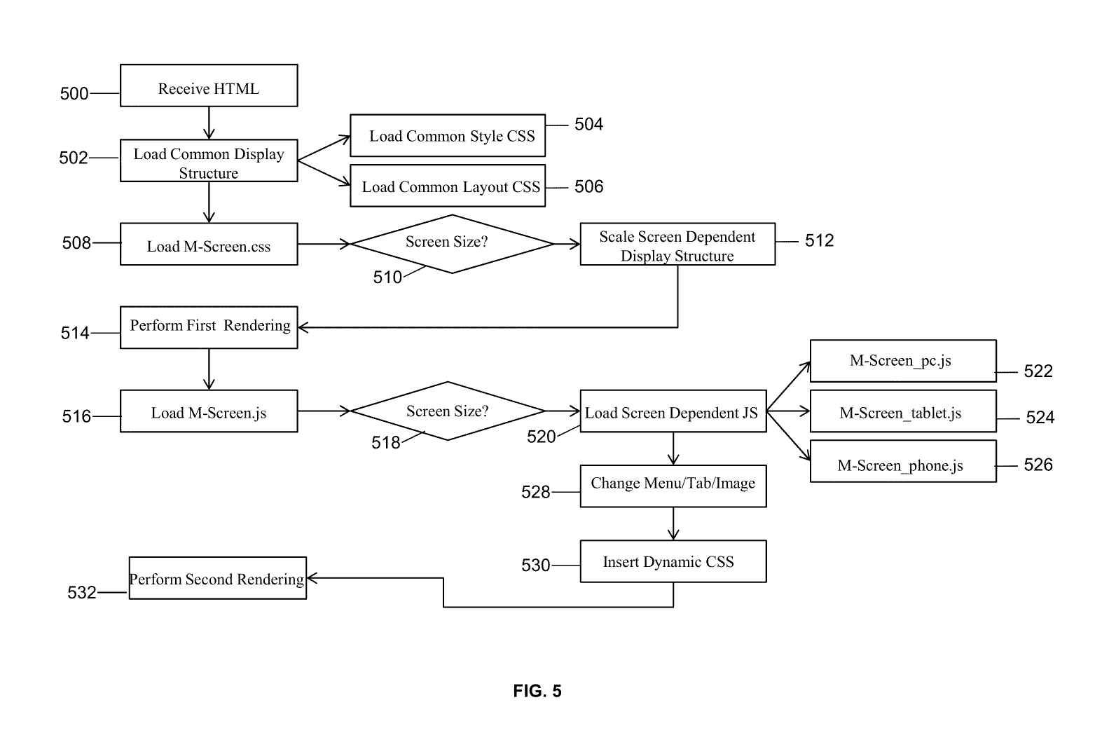

FIG. 5 shows a detailed example method flow diagram for providing a common user interface for each of multiple devices via cascading style sheet (CSS) and javascript according to an embodiment of the present invention. As illustrated in FIG. 5, at 500, hypertext markup language (HTML) is loaded or received and intended for display on different display devices. The display devices of the example include a smartphone, a tablet, and a PC. At 502, a common layout structure is determined. At 504 and 506, the common layout structure load includes loading a common style CSS and a common layout CSS. At 508, the CSS (i.e., the common layout structure) is loaded. This provides a common “look and feel” for each display device, such as common colors and common shapes and images.

At 510, the screen size of the display device is determined using media queries. At 512, the common layout structure for the display device is scaled using the media queries. Without media queries, fluid layouts would struggle to adapt to the array of screen sizes on the hundreds of devices out there. Fluid layouts can appear cramped and unreadable on small mobile devices and too large and chunky on big widescreen displays. Media queries make it possible to adapt typography to the size and resolution of the user's device, making it a tool for crafting a more pleasurable device experience.

At 514, a first rendering of the data is performed after the scaling process is performed. At 516, a JavaScript load process is performed to optimize the respective user interface. At 518, a screen size of a display area of the display device is determined. For example, a screen size of 700 px (or pixel width of 700 pixels) may be defined as a smartphone. A screen size of more than 700 px, but less then 1280 px, may be defined as a tablet. A screen size of more than 1280 px may be defined as a PC. At 520, the JavaScript that is loaded is determined by the screen size of the display device. For example, at 522, a JavaScript module for a PC may be loaded when the device type is determined to be a PC. At 524, a JavaScript module for a tablet may be loaded when the device type is determined to be a tablet. At 526, a JavaScript module for a smartphone may be loaded when the device type is determined to be a smartphone.

At 528, the JavaScript is used to alter the scaled common layout structure. For example, the JavaScript may change a HTML markup menu, a tab, and/or an image file in order to optimize a user interface. At 530, the CSS is modified by the JavaScript module that is used. At 532, a second rendering of the data using the modified common layout structure is performed. The second rendering is displayed on the screen of the display device as a common user interface.

It should be noted that, in some alternative implementations, the functions noted in the blocks may occur out of the order noted in FIGS. 4 and 5. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

An exemplary common user interface tool may be described in the general context of computer-executable instructions, such as program modules, being executed by a display device. Generally, program modules include routines, programs, people, components, logic, data structures, and so on that perform particular tasks or implements particular abstract data types. Furthermore, an implementation of an exemplary common user interface tool may be stored on or transmitted across some form of computer readable media. Computer readable media can be any available media that can be accessed by a display device. By way of example, and not limitation, computer readable media may comprise “computer storage medium” and “communications media.”

“Computer storage medium” may include volatile and non-volatile, removable and non-removable media implemented in any method or technology for storage of information such as computer readable instructions, data structures, program modules, or other data. Computer storage medium includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a display device.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for providing a common user interface for multiple display devices. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for displaying a common user interface on a display device among a plurality of display devices, comprising:
receiving data intended for display on a display device having a screen;
loading a common layout structure;
determining a size of the screen;
scaling the common layout structure based on the size of the screen;
performing a first rendering of the data using the scaled common layout structure;
modifying the scaled common layout structure based on the size of the screen;
performing a second rendering of the data using the modified common layout structure; and
displaying the second rendering on a screen of a display device as a common user interface.

2. The computer-implemented method of claim 1, wherein the data is formatted as hypertext markup language (HTML).

3. The computer-implemented method of claim 1, wherein the size of the screen is determined using at least one media query.

4. The computer-implemented method of claim 1, wherein the size of the screen is calculated as the width of the screen in pixels.

5. The computer-implemented method of claim 1, wherein the common layout structure comprises at least one cascading style sheet (CSS).

6. The computer-implemented method of claim 1, wherein the step of modifying the style of the scaled common layout structure is performed using a JavaScript module.

7. The computer-implemented method of claim 1, wherein the display device comprises on of a smartphone, tablet, or personal computer (PC).

8. A system for displaying a common user interface on a display device among a plurality of display devices, comprising:
a receiving component configured to receive data intended for display on a screen of a display device;
a loading component configured to load a common layout structure;
a determining component configured to determine a size of the screen;
a scaling component configured to scale the common layout structure based on the size of the screen;
a rendering component configured to perform a first rendering of the data using the scaled common layout structure;
a modifying component configured to modify the scaled common layout structure based on the size of the screen;
the rendering component further configured to perform a second rendering of the data using the modified common layout structure; and
a providing component configured to provide the second rendering to the display device as a common user interface.

9. The common user interface tool of claim 8, wherein the data is formatted as hypertext markup language (HTML).

10. The common user interface tool of claim 8, wherein the size of the screen is determined using at least one media query.

11. The common user interface tool of claim 8, wherein the size of the screen is calculated as the width of the screen in pixels.

12. The common user interface tool of claim 8, wherein the common display structure comprises at least one cascading style sheet (CSS).

13. The common user interface tool of claim 12, wherein the at least one CSS comprises one of a style CSS or layout CSS.

14. The common user interface tool of claim 8, wherein the step of modifying the scaled common layout structure is performed using a JavaScript module.

15. A computer program product for generating a common user interface for a display device among a plurality of display devices, the computer program product comprising a computer readable storage medium, and program instructions stored on the computer readable storage medium, to:
receive data intended for a screen of a display device;
load a common layout structure;
determine a size of the screen;
scale the common layout structure based on the size of the screen;
perform a first rendering of the data using the scaled common layout structure;
modify the scaled common layout structure based on the size of the screen; and
perform a second rendering of the data using the modified common layout structure, wherein the second rendering represents a common user interface.

16. The computer program product of claim 15, wherein the data is formatted as hypertext markup language (HTML).

17. The computer program product of claim 15, wherein the size of the screen is determined using at least one media query.

18. The computer program product of claim 15, wherein the size of the screen is calculated as the width of the screen in pixels.

19. The computer program product of claim 15, wherein display structure comprises at least one cascading style sheet (CSS).

20. The computer program product of claim 15, wherein the style of the common layout structure is modified using a JavaScript module.

21. The computer program product of claim 15, the computer readable storage medium further comprising instructions to generate output data capable of reproducing the common user interface when executed.
